(19) United States
(12) Patent Application Publication
(10) Pub. No.: US 2006/0158141 A1
(43) Pub. Date: Jul. 20, 2006

(54) Low power solid state brake switch

(76) Inventors: Carl B. Frank, Sharon, MA (US); Jeffrey Patrick Rudd, Foxboro, MA (US); Ronald I. Frank, Sharon, MA (US); Anh Le, Pembroke, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/219,534

(22) Filed: Sep. 2, 2005

Related U.S. Application Data
(60) Provisional application No. 60/607,384, filed on Sep. 3, 2004.
(60) Provisional application No. 60/610,445, filed on Sep. 16, 2004.

(51) Int. Cl. H02P 7/06

(52) U.S. Cl. 318/254

(57) ABSTRACT

A switch assembly including a mounting base and a switch housing including a non-contact switch. The switch assembly also include a calibration feature that is movable between a first position and a second position. The switch assembly may be positioned relative to a target with the calibration feature in the first position. The calibration feature may then be retracted to a second position in order to provide an airspace between the switch housing an a target.

### CROSS-REFERENCE TO RELATED APPLICATIONS

This application claims the benefit of U.S. provisional patent application Ser. No. 60/607,384, filed Sep. 3, 2004, and also claims the benefit of U.S. provisional patent application Ser. No. 60/610,445, filed Sep. 16, 2004. The entire disclosure of both applications are incorporated herein by reference.

### FIELD

The present disclosure relates to position sensing, and more particularly to non-contact position sensing.

### BACKGROUND

Hall Effect switches are generally designed to change their output state based on a sensed magnetic field. This design attribute, however, means that a Hall Effect switch is susceptible to excessively high magnetic fields produced by foreign, external sources such as a magnetized wrench and magnetized steel shank boots, etc.

Another limitation associated with Hall Effect switches is the amount of electrical current that must be supplied to the switch by an external power supply in order to keep the Hall Effect switch properly operating. Typically, a Hall switch may consume in the range of about 1-10 milliamperes of current in order to perform its basic function. More recent developments in Hall switch technology have added timing logic, which turns the Hall Effect circuit “on” and “off at a specific duty cycle. A timing logic having a fixed duty cycle results in a lower overall current required from the external power supply. Using such timing logic, Hall switches may be provided with low current consumption, for example approximately 200 microamperes. While the current consumption of the Hall Effect circuit may be reduced using timing logic, one drawback associated with a duty cycle timing configuration that produces low current consumption is an increased delay time in the capability of the switch to react to a change in states. This drawback may be especially pronounced when the switch is being employed as a proximity sensor. For fast acting switch times on the order of 100 microseconds, the required timing logic may require a duty cycle that actually increases the overall current consumption. Based on general Hall switch specifications, faster response times require higher current consumption. Conversely, the lower current consumption is achieved at the expense of longer switch response times.

In the area of brake pedal switches, attempts have been made to replace conventional electromechanical plunger or contact type switches with proximity type switches. Calibration of the location of a proximity brake switch relative to a flag/target located on the brake pedal assembly is an important and difficult aspect of the switch installation. The difficulties associated with properly calibrating a proximity switch have impeded the replacement of electromechanical and contact type switches with proximity switches in such applications. Proper calibration is required because of the large tolerances in the pedal assembly versus the small tolerance allowed for the switch operating point. Typical calibration methods may rely on the vehicle's “up” pedal stop to locate the switch or some part of the switch relative to the switch's mounting position. According to such a calibration method, the calibration sequence may be to first install the switch in the mounting feature. At that time either the switch or some part of the switch mounting assembly is adjusted to be too far forward. Accordingly, the pedal's flag or target will contact the switch before the pedal reaches its upper limit of travel. Next, the pedal may be pulled up to its upper stop. Pulling the pedal up to the upper stop may calibrate the change of state point for the switch. This design, however, may allow the pedal to contact the switch as it reaches its upper stop. The contact between the pedal and the switch may produce an undesirable noise which and/or may result in movement of the switch to a new location if the pedal stop is not rigidly located. Additionally, in the preceding method the location of the switch may be fixed using a detent mechanism that may provide only discrete steps, making the calibration window wider than necessary.

### BRIEF DESCRIPTION OF THE DRAWINGS

Features and advantages of the present invention are set forth by way of embodiments consistent therewith, wherein:

FIG. 1 is a graph illustrating the linear sensor output of a Hall Effect switch consistent with the present disclosure;

FIG. 2 is a functional block diagram of a programmable logic circuit consistent with the present disclosure; and

FIGS. 3 is a perspective view of an embodiment of a switch assembly consistent with the present disclosure;

FIG. 4 is another perspective view of an embodiment of a switch assembly consistent with the present disclosure;

FIG. 5 is a perspective view of an embodiment of a switch assembly consistent with the present disclosure showing a calibration shim in a retracted position;

FIG. 6 is a perspective view of an embodiment of a mounting base of a switch assembly consistent with the present disclosure;

FIG. 7 shows an embodiment of a switch housing that may suitably be used in connection with a switch assembly consistent with the present disclosure;

FIG. 8 is a perspective view of an embodiment of a calibration shim consistent with the present disclosure;

FIG. 9 is a side cross-sectional view of an embodiment of a switch assembly consistent with the present disclosure showing the switch assembly assembled to a mounting plate;

FIG. 10 is a side cross-sectional view depicting the use of a calibration shim of a switch assembly consistent with the present disclosure;

FIG. 11 is a side cross-sectional view of an embodiment of a switch assembly with the calibration shim in a retracted position;

FIG. 12 is a top cross-sectional view of an embodiment of a switch assembly consistent with the present disclosure assembled to a mounting plate;

FIG. 13 is a perspective view of another embodiment of a switch assembly consistent with the present disclosure;

FIG. 14 is a perspective view of the switch assembly of FIG. 13 illustrating a calibration feature of the switch assembly;

FIG. 15 is a perspective view of the switch assembly of FIG. 13 calibrated consistent with the present disclosure;

FIG. 16 is a left side elevation view of an embodiment of a switch assembly consistent with the present disclosure;

FIG. 17 is a front elevation view of an embodiment of a switch assembly consistent with the present disclosure;

FIG. 18 is a bottom view of an embodiment of a switch assembly consistent with the present disclosure;

FIG. 19 is a right side elevation view of an embodiment of a switch assembly consistent with the present disclosure;

FIG. 20 is an exploded view of an embodiment of a switch assembly consistent with the present disclosure;

FIG. 21 is a graph of gauss versus separation for an embodiment of a switch assembly consistent with the present disclosure;

FIG. 22 is another graph of gauss versus separation for an embodiment of a switch assembly consistent with the present disclosure;

FIG. 23 depicts an embodiment of an electronic circuit that may be employed to provide quick response time and improve switch point control of a switch consistent with the present disclosure;

FIG. 24 depicts an embodiment of an electronic circuit that may provide reduced power consumption and quick response time of a switch consistent with the present disclosure;

FIG. 25 depicts an embodiment of an electronic circuit that may provide improved switch point control, reduced power consumption, and quick response time of a switch consistent with the present disclosure;

FIG. 26 is a graph of power consumption versus response time for an embodiment of a switch consistent with the present disclosure;

FIGS. 27a and 27b depict an embodiment of a non-contact switch and an associated magnetic field vector plot for the embodiment of a switch consistent with the present disclosure; and

FIGS. 28a and 28b shown another embodiment of a non-contact switch and an associated magnetic field vector plot for the embodiment of a switch consistent with the present disclosure.

### DESCRIPTION

Various features and advantages of the subject matter of the present disclosure are set forth by way of description of embodiments consistent therewith. Many of the embodiments pertain to non-contact brake switches utilizing a Hall Effect switch as the non-contact switch. It should be appreciated, however, that the subject matter of the present disclosure is equally applicable to non-contact switches in applications other than brake switches. Similarly, it should be appreciated that embodiments of non-contact or proximity sensors and switches may be provided employing non-contact sensors and/or switches other than Hall Effect-type switches. As such, these aspects of the disclosed embodiments should not be considered to be limiting on the scope of the present disclosure.

According to one aspect, the present disclosure is directed at a Hall Effect proximity sensor having switch diagnostics that may detect the loss of a magnetic field and/or may detect the presence of an increased or excessive magnetic field. According to one particular embodiment, the proximity sensor may be employed as a non-contact brake pedal switch. As such, the proximity sensor may replace a conventional electromechanical plunger-type switch in such an application.

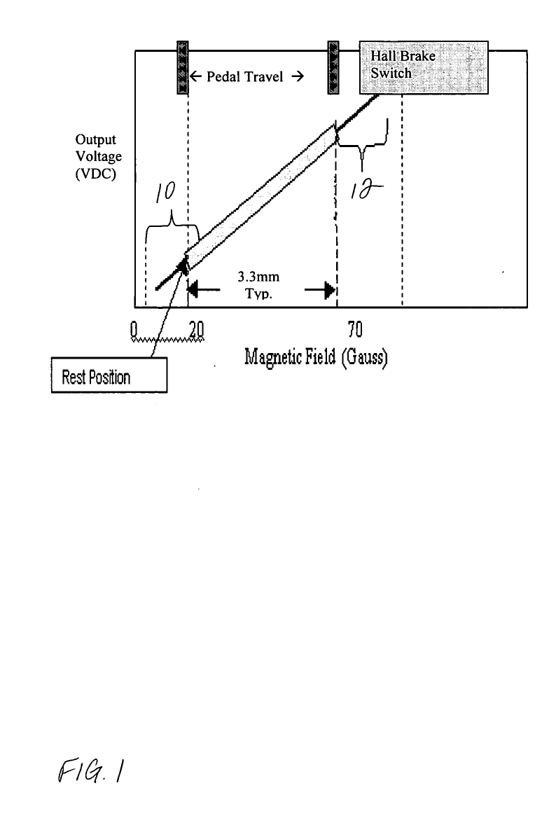

With reference to FIG. 1, a proximity sensor including a Hall Effect switch consistent with the present disclosure may utilize fault diagnostics for detecting a low and/or excessively high magnetic field, as may result from the loss of back biased magnet or from foreign external magnetic sources. A fault diagnostic system herein may utilize detection logic to compare a sensed magnetic field to a predetermined upper and lower threshold. The magnetic detection circuit may use the linear characteristic of a Hall Effect sensor to determine normal switch point levels and establish predetermined fault thresholds for low and high magnetic fields. The linear Hall sensor transfer function is shown in FIG. 1.

When the sensed magnetic field exceeds either the upper or lower threshold due to a low or high magnetic field, the Hall switch may change output states to indicate that a switch fault condition has been detected. According to one embodiment suitable for use in brake switch and/or similar applications, the switch design may include a single housing containing a magnet and Hall Effect switch device. The magnet and Hall switch may be orientated to produce a back biased magnetic field, which is generated by the internal magnet. A moveable external ferrous target or flag may be mounted on the brake pedal. As the target moves away from the magnet/Hall Effect switch device, e.g. due to the brake pedal being depressed, the Hall Effect brake switch changes its output from “On” to “Off” state. The fault diagnostics consistent with this disclosure may detect a change in magnetic field below a low magnetic threshold 10 resulting from either a damaged or missing magnet. Similarly, the fault diagnostics consistent with the present disclosure may detect a change in magnetic field above the high magnetic threshold 12 resulting from the presence of an interfering magnetic field.

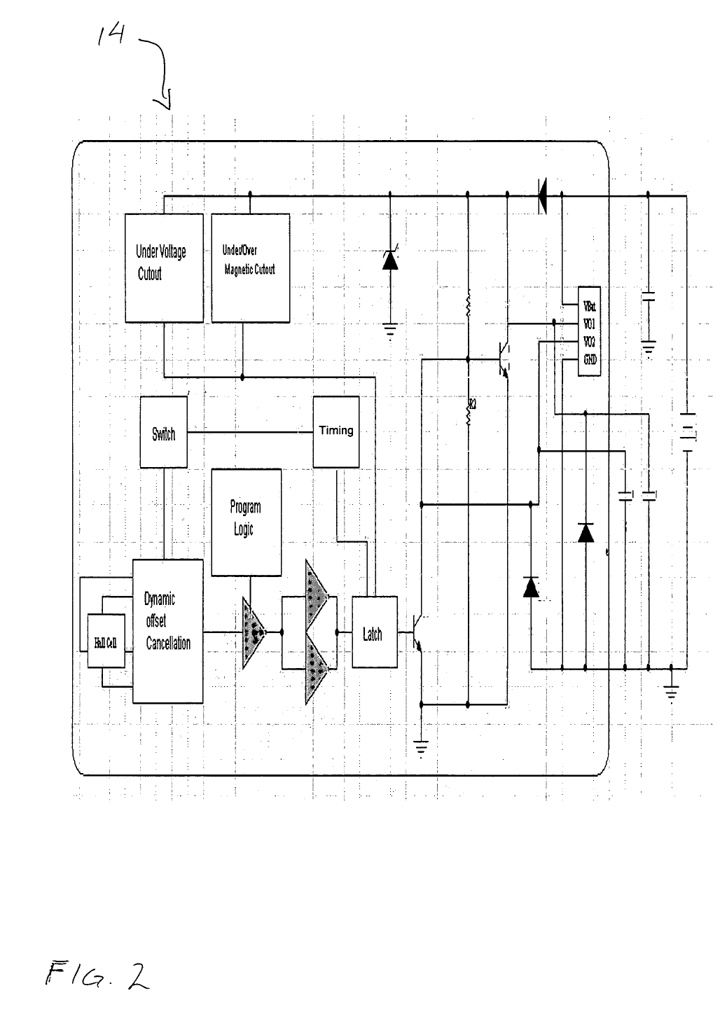

Consistent with another aspect, the present disclosure may provide a timing logic having a programmable and variable duty cycle. The timing logic having a programmable duty cycle may allow an end user to select the current consumption and switch response time characteristics of a Hall Effect switch in a proximity sensor. An embodiment of programmable logic 14 that may be used to select current consumption and switch response time consistent with the present disclosure is set forth in the functional block diagram of FIG. 2.

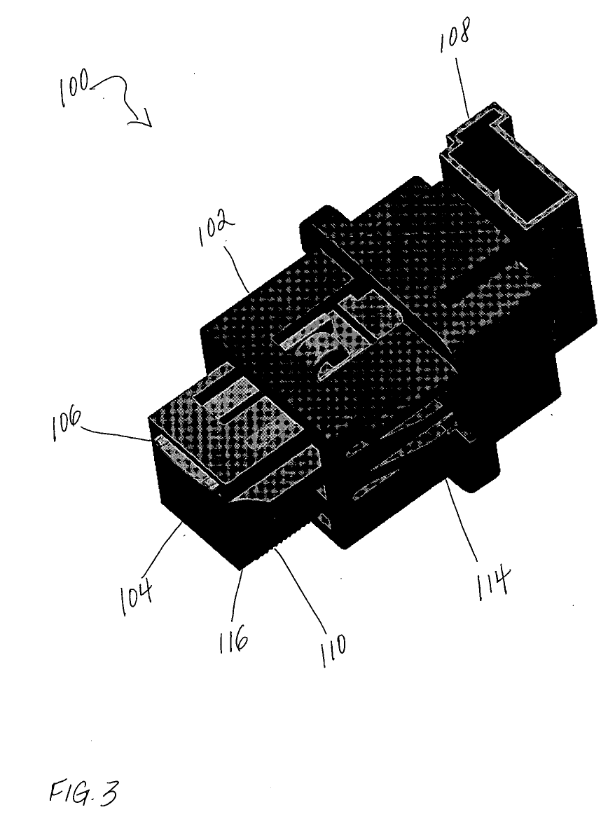

With reference to FIGS. 3 through 12, according to another aspect, the present disclosure is directed at an assembly that may be used to perform in-situ calibration of a proximity sensor relative to a target or flag, e.g. a member whose proximity is being sensed by the proximity sensor. In one particular embodiment the target may be a pedal assembly or component of such an assembly, such as a brake pedal assembly or component thereof. The mechanical switch calibration assembly may allow the proximity sensor to be easily adjusted and positioned to match a desired switch point, e.g. to match the switch point of the proximity sensor with normal pedal travel. Accordingly, the non-contact proximity switch herein may suitably be employed for automotive and commercial vehicle applications such as shift levers, parking brakes, and all types of pedals and throttle and throttle body assemblies.

In the context of a non-contact brake sensor for sensing at least one position of a brake pedal, a calibration assembly consistent with the present disclosure may allow the pedal to over-travel beyond its calibrated stop without recalibrating, or moving, the switch. In the case of “non contact” type switches this feature may prevent the switch and target from contacting and making an undesirable noise. According to one embodiment, a mechanical assembly consistent with the foregoing may use an integral shim to establish a physical air-gap between the pedal and the non-contact brake switch. Calibrating the switch consistent with the present disclosure may use an internal, moveable shim that is configured to recede into the brake switch housing after the switch has been calibrated. The brake pedal flag may be pushed against the adjustment shim, which may extend beyond the brake pedal switch housing to thereby set the positional relationship between the pedal flag and the brake switch and thus calibrate the switch body inside a fixed mounting base. After calibration of the switch position has been completed, the brake pedal flag may return to its free (off) position. An integral spring of the shim may reset the shim to move the shim inside the switch housing, i.e. move the shim so that it does not extend beyond the end of the switch housing. The pedal flag may then have a clearance relative to the switch body as determined by the length of the shim design.

According to one aspect, the calibration assembly herein may provide infinite calibration adjustment, e.g., of a brake switch sensor. The calibration assembly may include locking ribs on the switch housing that may be wedged into the mounting base during the calibration process described above, thereby maintaining the desired position of the switch housing within the mounting base. According to another aspect, the switch housing may include a ratchet feature which may provide limited step adjustment of the switch. According to one embodiment, the increments of step adjustment provided by the ratchet feature may be on the order of approximately 0.5 mm. However, the step adjustment provided by the ratchet feature may be varied by any degree based on desired design attributes.

Turning to FIG. 3, an embodiment of a proximity brake switch assembly 100 according to the present disclosure is illustrated including a mounting base 102 and a brake switch housing 104 including a calibration shim 106. As illustrated, the brake switch housing 104 may be configured to be at least partially received through an opening in the mounting base 102. The calibration shim 106 may be extendable from a front face of the switch housing 104 to allow the face of the switch housing 104 to be positioned a desired distance from the target or flag.

The switch housing 104 may include a non-contact or proximity switch (not shown) at least partially disposed therein. The switch housing 104 may further include an integral switch connector 108, although other wiring configurations, such as pigtail connectors, may also be used herein. With additional reference to FIG. 7, at least a portion of the switch housing 104 may include an adjusting ratchet feature 110. According to one embodiment, the adjusting ratchet feature 110 may include series of notches or teeth extending along at least a portion of the length of the switch housing 104. The ratchet feature 110 may allow the switch housing 104 to interact with a cooperating feature (not shown) in the mounting base 102 and allow the switch housing 104 to be maintained in the mounting base 102 at desired extension relative to the mounting base 102.

The mounting base 102, also illustrated individually in FIG. 6, may be configured to be positioned and retained to a mounting feature, for example, of a pedal assembly. As shown in the illustrated embodiment, the mounting base 102 may include one or more outwardly extending flanges 112 or other features that may allow the base 102 to be located in a mounting opening etc., for example of a pedal assembly. The mounting base 102 may also include one or more retaining wedges, e.g. 114. The retaining wedges 114 may be configured, for example, as resiliently deflectable, or snap-fit-type features. The mounting base 102 may be positioned within a mounting opening, e.g. extending through a mounting plate, such that the flange 112 contacts a first side of the mounting plate. The retaining wedges 114 may engage a second opposing side of the mounting plate to secure the mounting base 102 to the mounting plate. According to one embodiment, two or more retaining wedges may be provided having a different spacing from the flange 112. Accordingly, a single mounting base 102 may be secured in mounting plates of different thickness. According to one embodiment, the switch housing 104 may include one or more ribs 116 that may contact an inside surface of the retaining wedges 114 when the switch housing 104 is positioned extending at least partially though the mounting base 102. The mounting base 102 may be secured in a mounting plate by the flange 112 and retaining wedges 114. The switch housing 104 may then be inserted into the mounting base 102, and the rib 116 may contact an inside surface of one or more of the retaining wedges 114 to prevent the retaining wedge 114 from deflecting inwardly and releasing the mounting base 102 from the mounting plate. Additionally, and/or alternatively, the rib 116 on the switch housing 104 may frictionally engage inner sidewalls of the mounting base 102 to thereby maintain the switch housing 104 in a desired position relative to the mounting base 102. The frictional engagement of the ribs 116 and the mounting base 102 may provide infinite adjustment of the switch housing 104 relative to the mounting base 102, as opposed to the incremental positioning available from the previously-described ratchet feature 110.

The shim 106, illustrated by itself in FIG. 8, may be extendable from the switch housing 104. Consistent with the illustrated embodiment, the shim 106 may be slidably disposed relative to the switch housing 104, thereby allowing the shim 106 to be slidably extendable relative to the switch housing 104. In the illustrated embodiment, the shim 106 may generally include a longitudinal portion 118 that may be slidably received in a channel 120, or similar feature, of the switch housing 104. In the particular embodiment of the switch housing 104 shown in FIG. 7, a portion of the channel 120 may be bridged 121, whereby the shim 106 may be slidably retained in the channel 120. The shim 106 may additionally include at least one resilient member, such as the integral spring feature 122 that may be configured to bear against a protrusion 124 in the channel 120 of the switch housing 104. The integral spring 122 may bear against the protrusion 124 to bias the shim 106 toward a retracted position relative to the switch housing 104. This feature is not, however, essential.

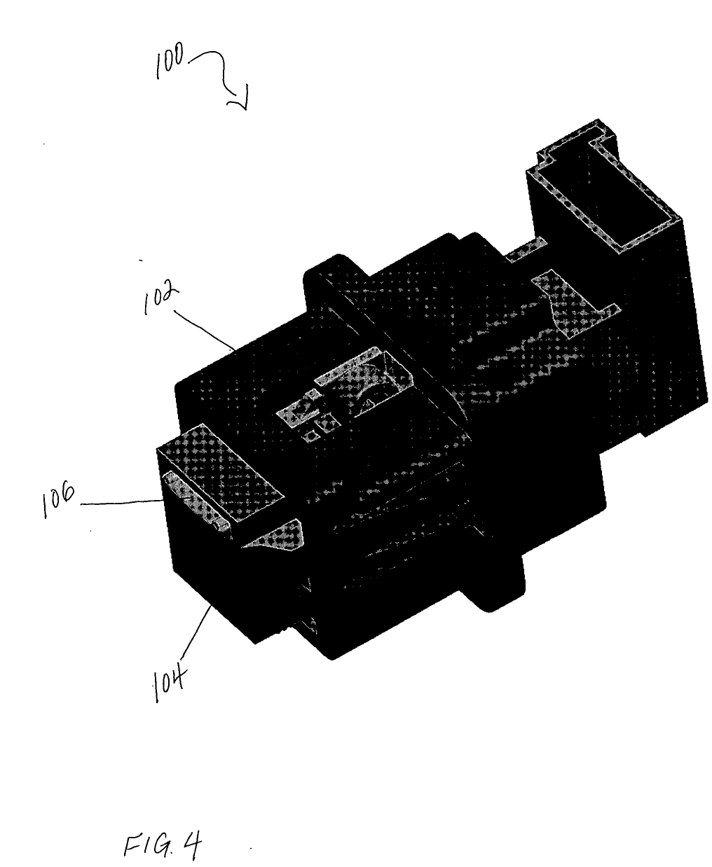

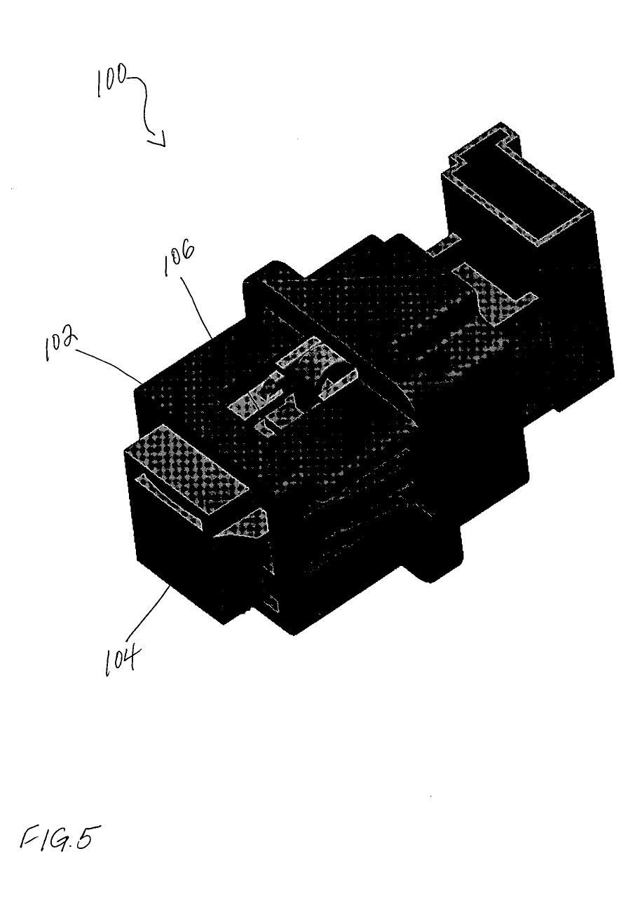

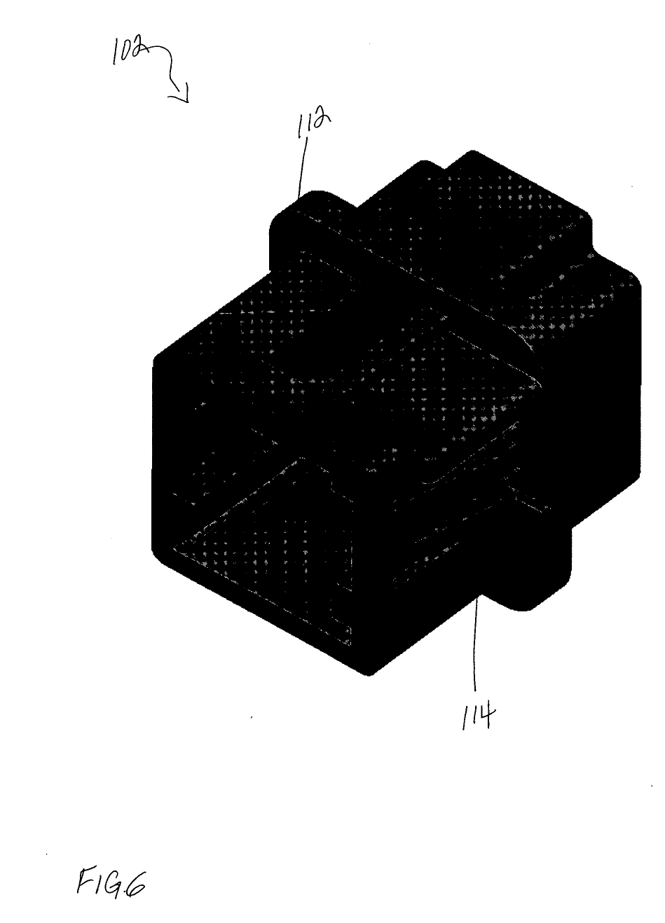

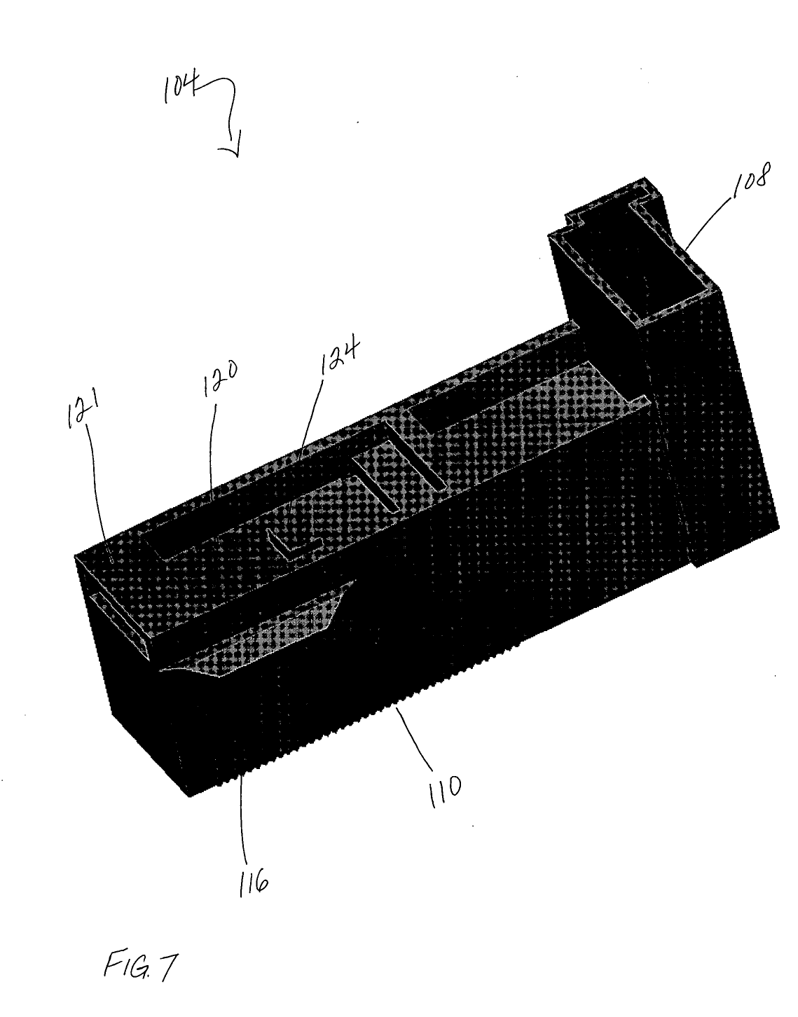

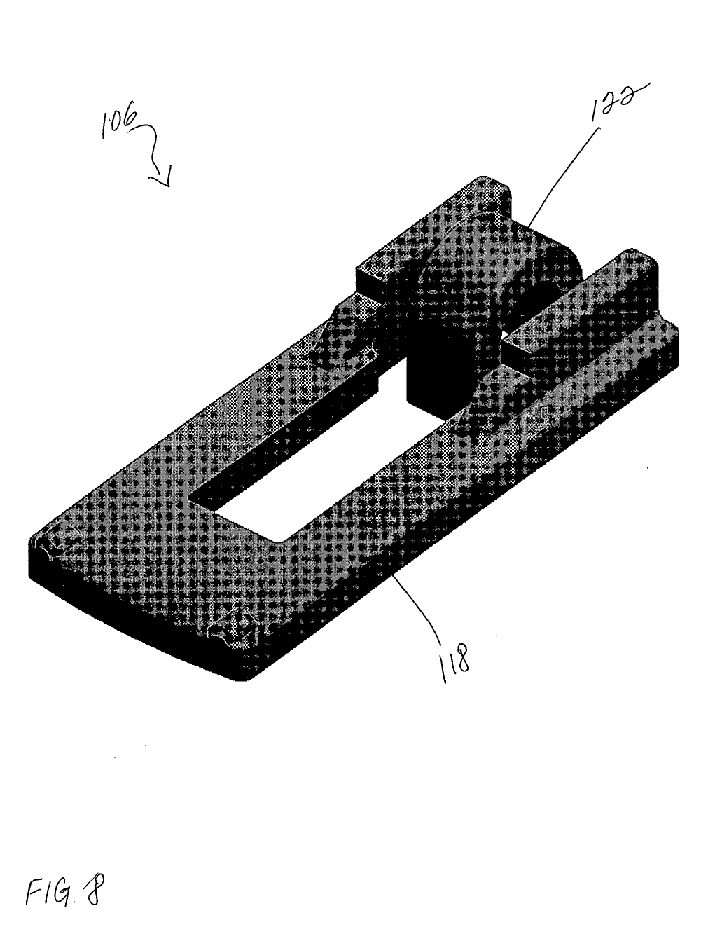

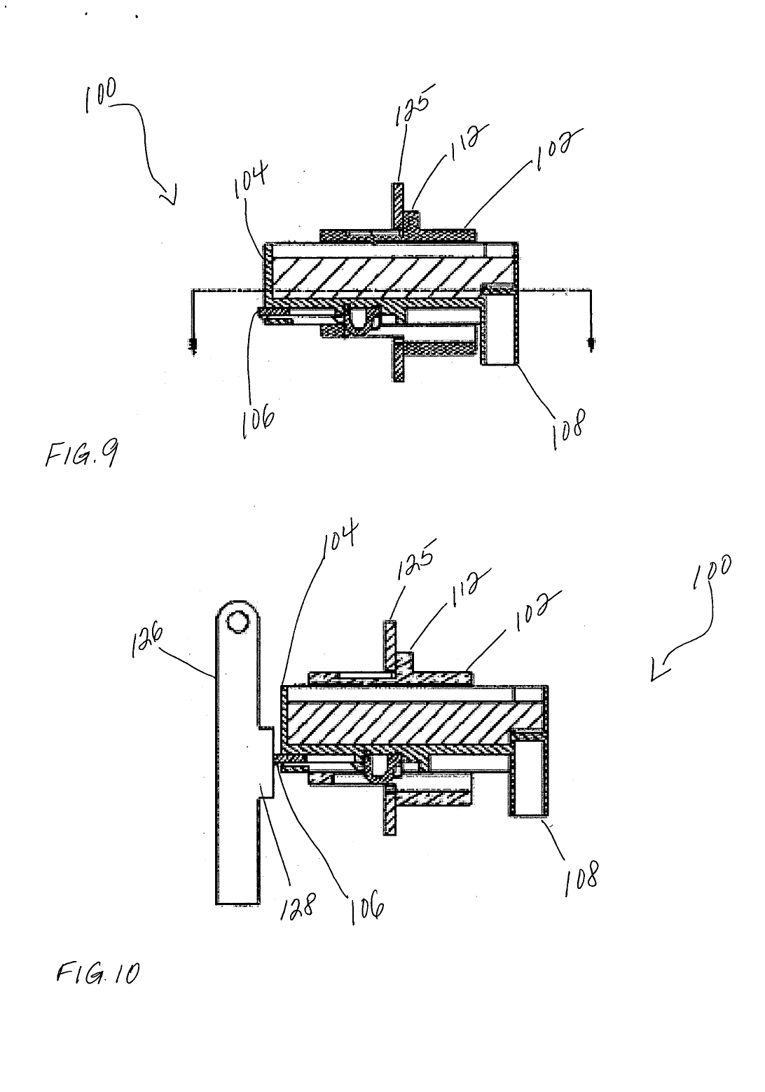

FIGS. 4 and 5 illustrate the brake switch 104 in a desired position within the mounting base 102, i.e., with the position of the switch 104 adjusted to be a desired distance from a target or flag, the proximity of which is sensed by the switch. FIGS. 4 and 5 respectively illustrate the switch assembly with the calibration shim 106 in an extended position and a retracted position.

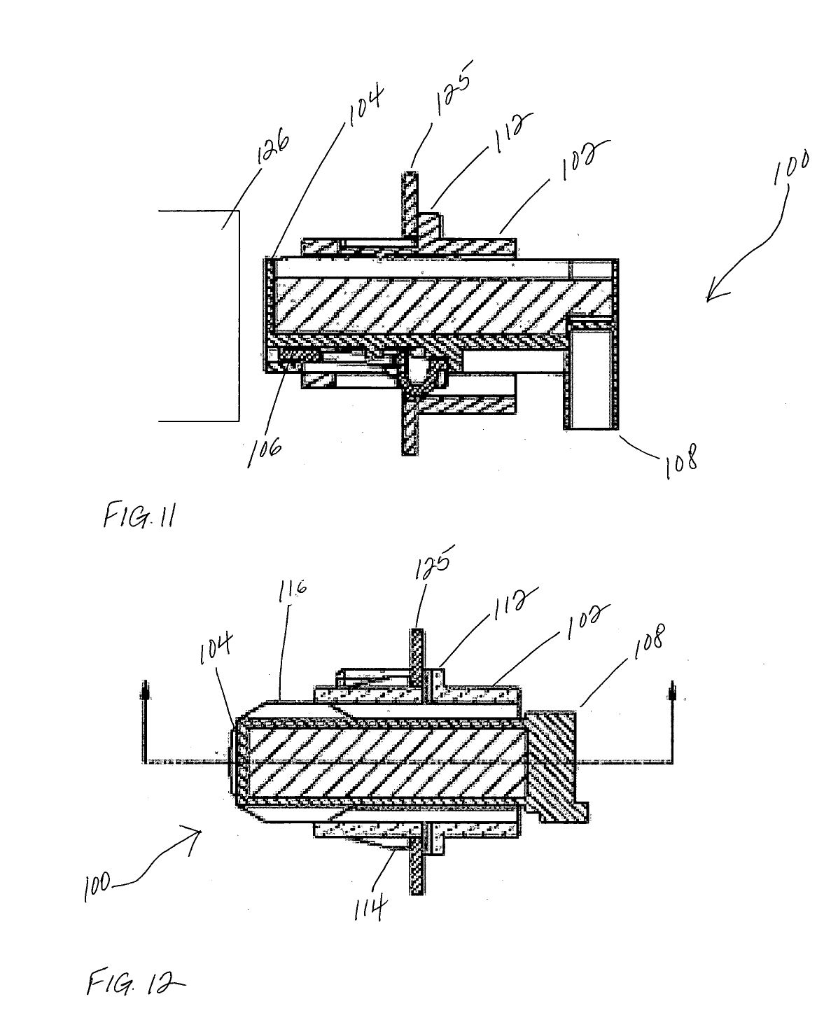

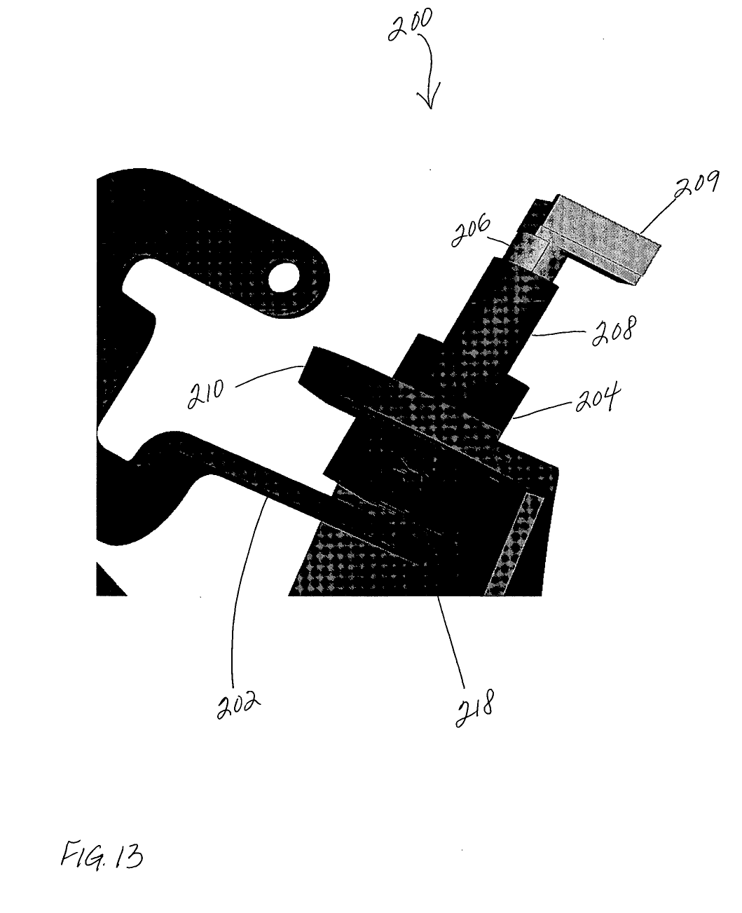

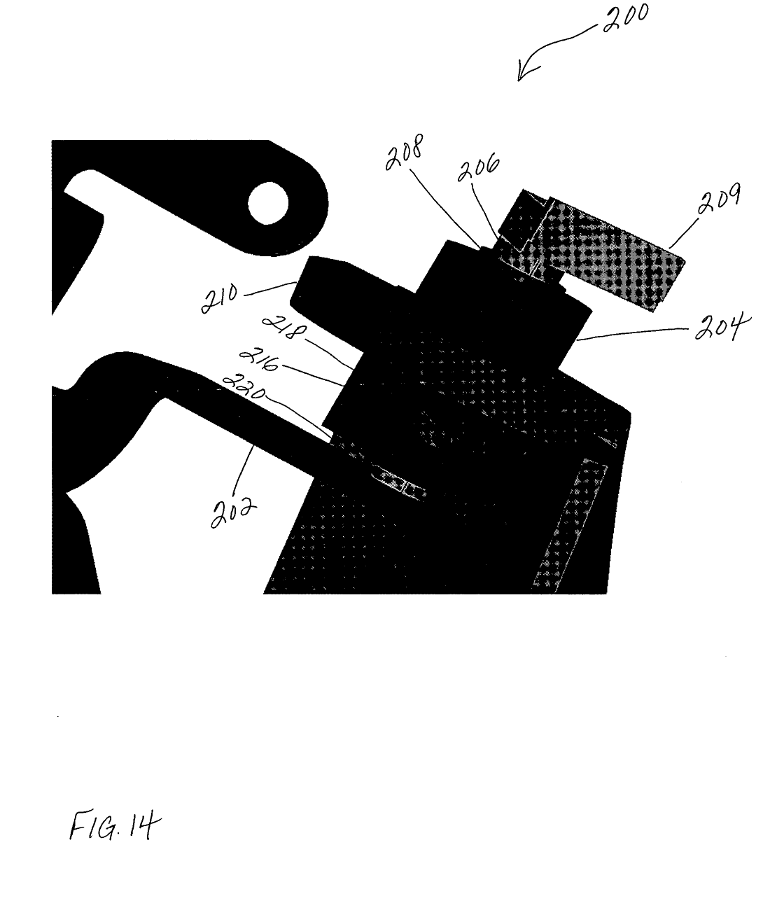

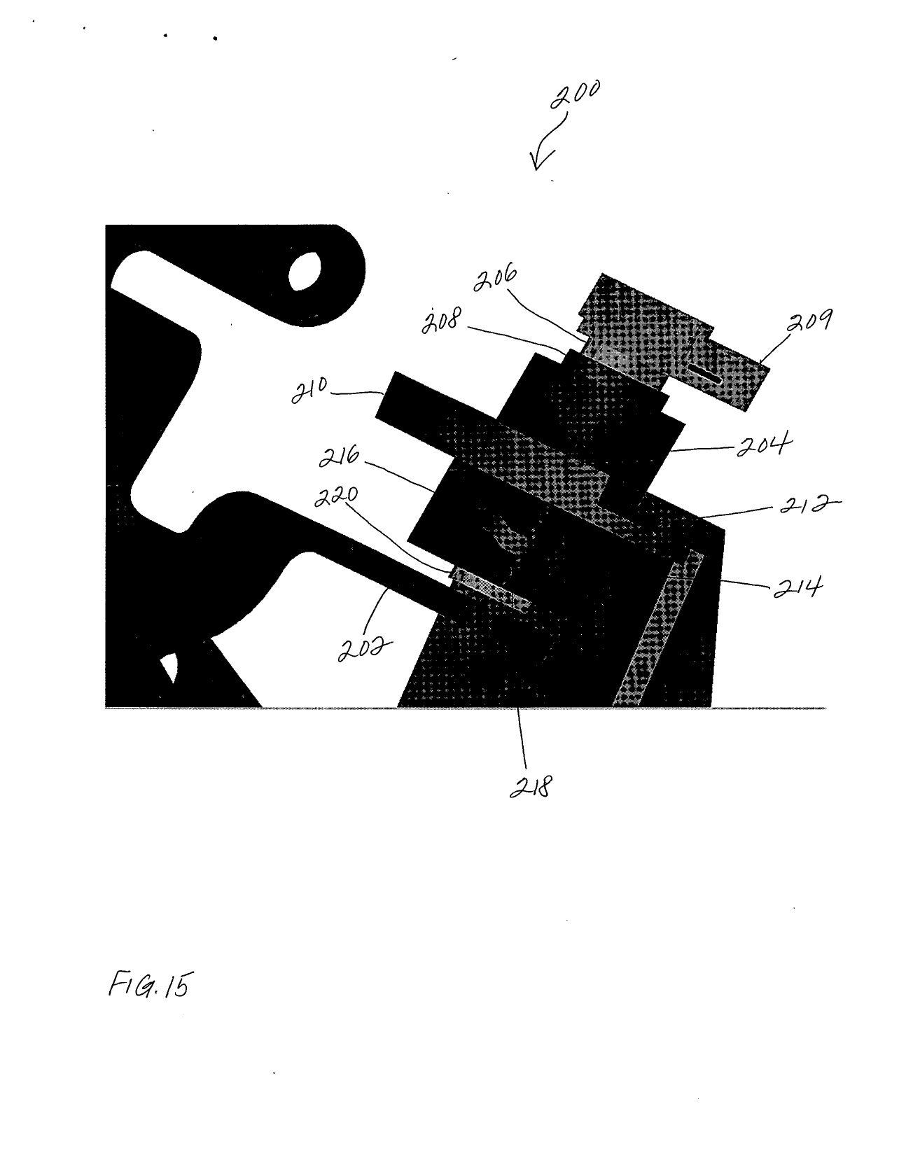

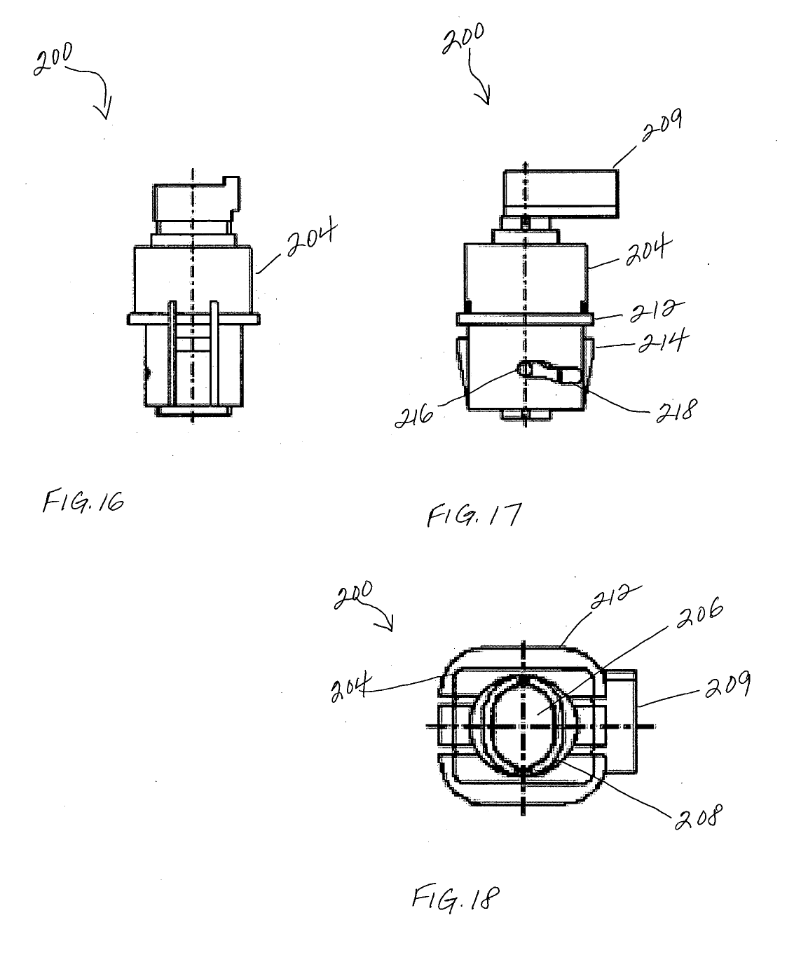

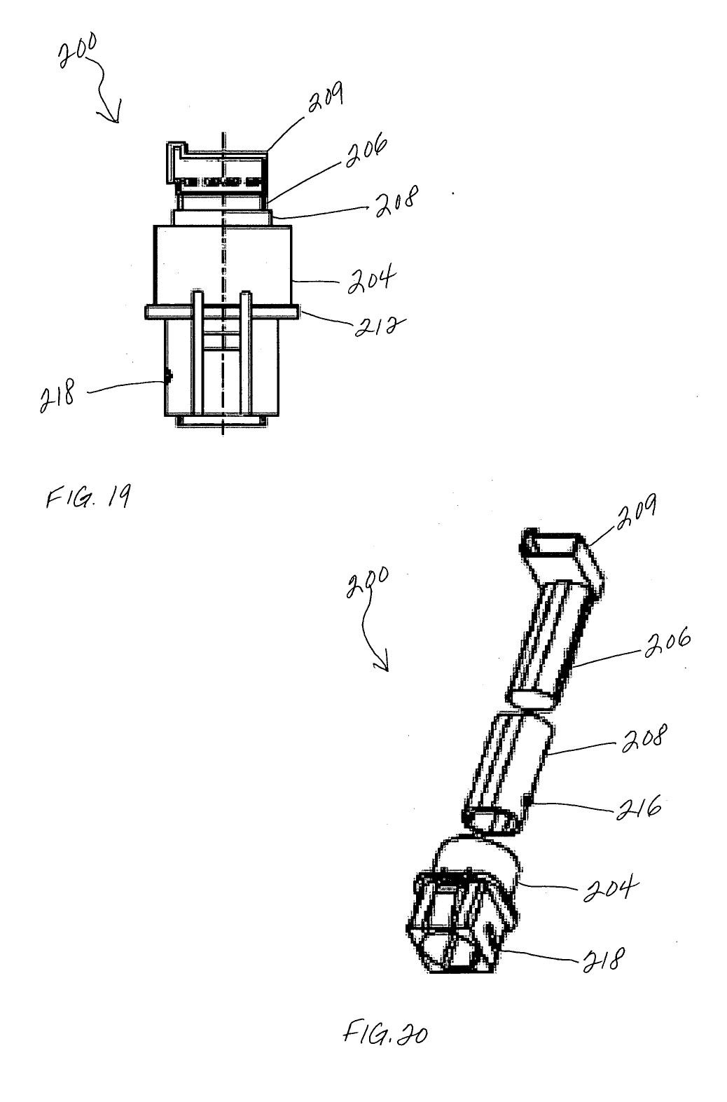

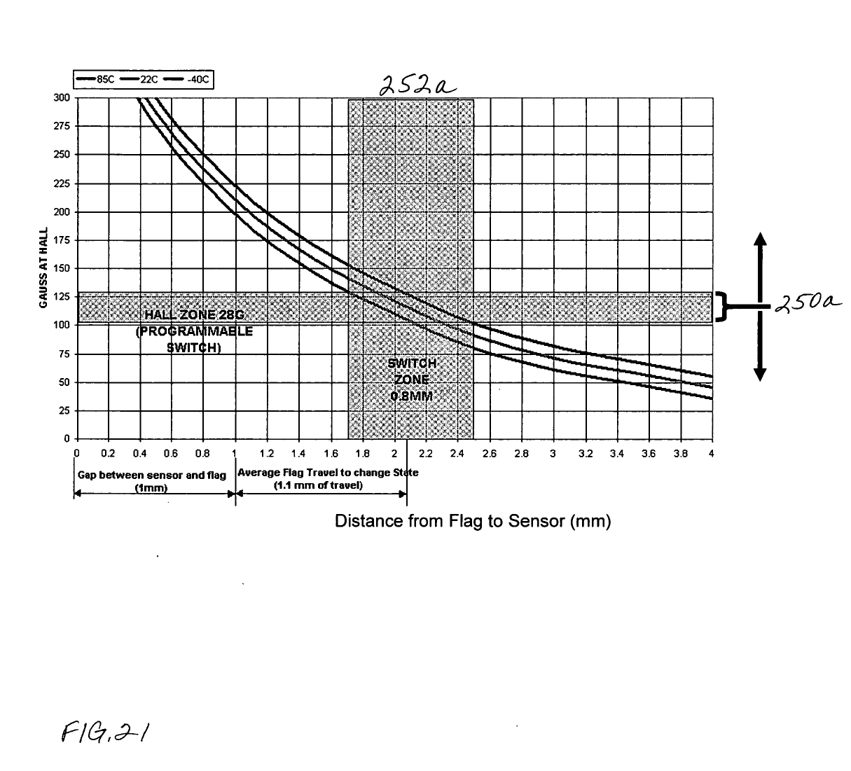

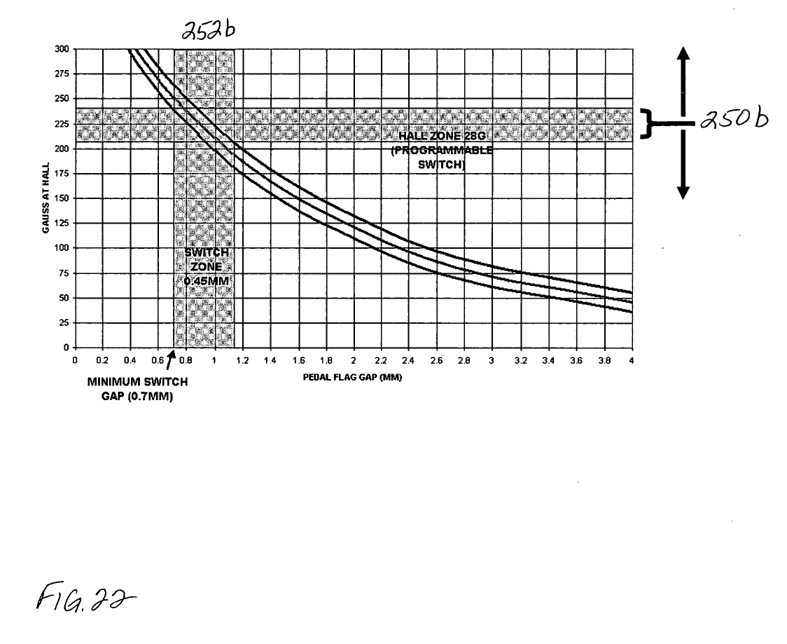

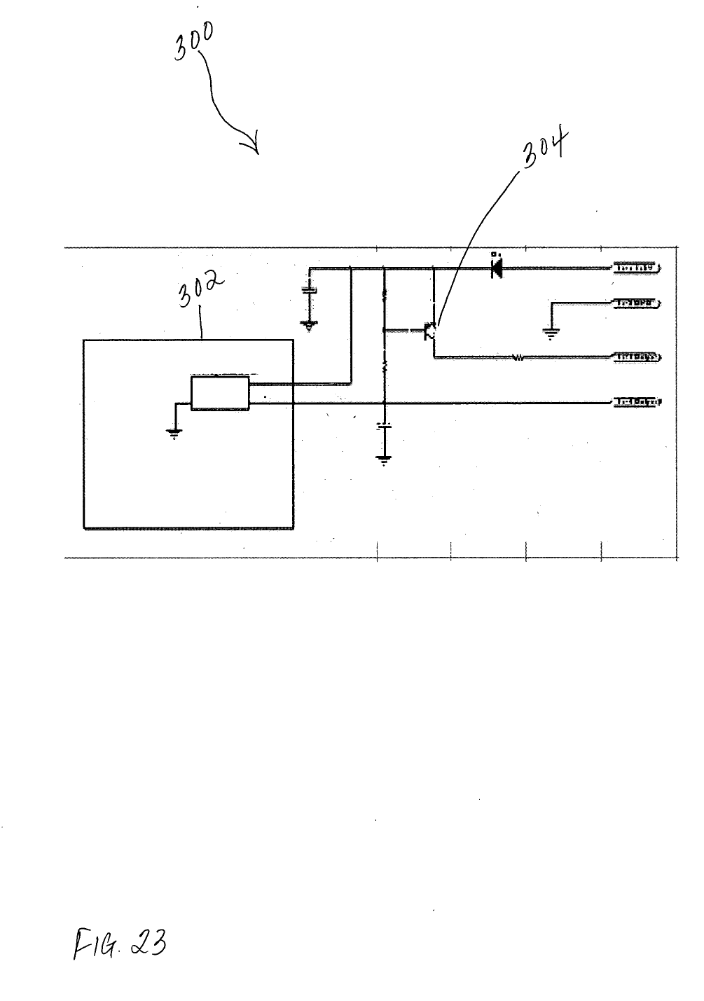

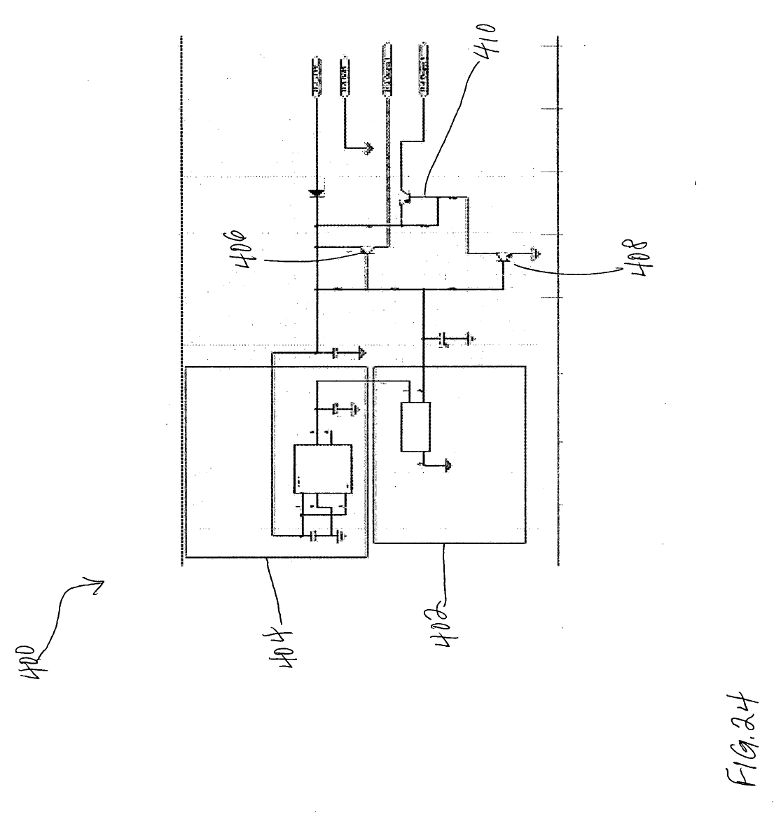

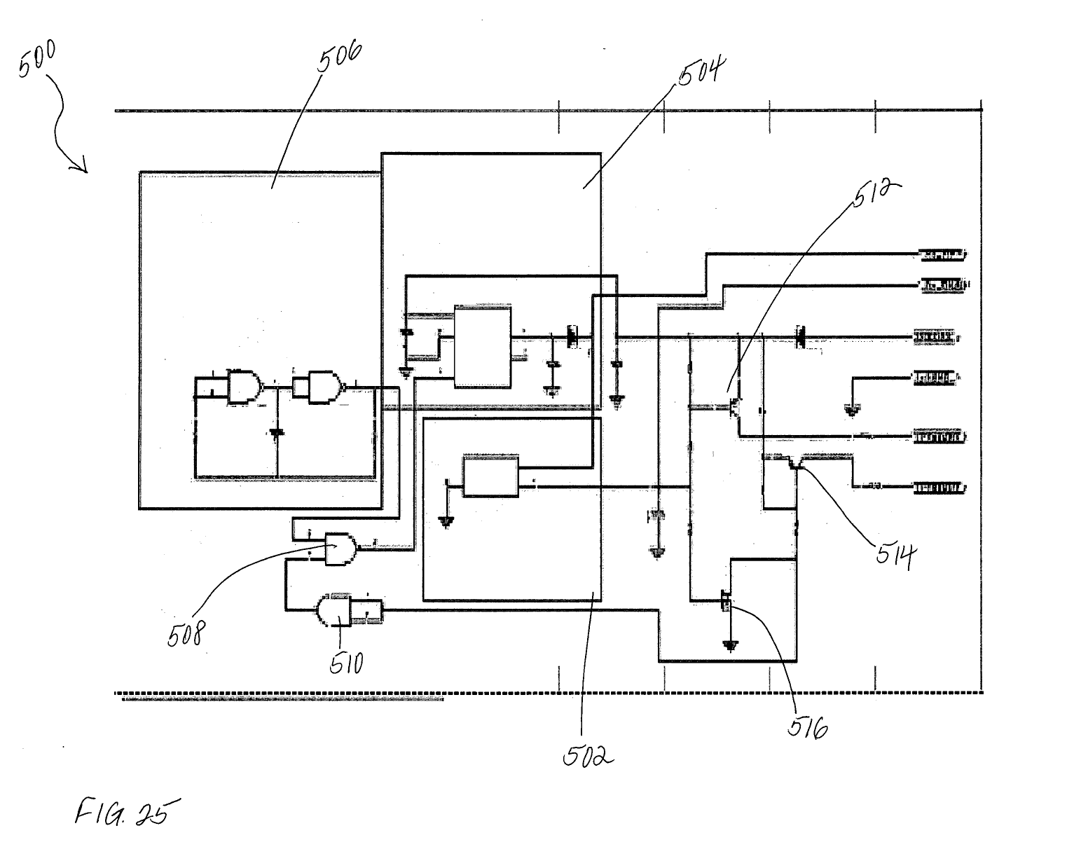

Referring to FIGS. 9 through 12, a calibration process consistent with the above described switch assembly 100 is illustrated and described. As shown in FIG. 9, the mounting base 102 may be assembled to a mounting plate 125 and the switch body 104 may be inserted extending through the mounting base 102. The shim 106 may be extended from the switch body 104 by a distance to provide a desired spacing. FIG. 12 more clearly shows the flange 112 of the mounting base disposed against the mounting plate 125 and secured in position by the wedges 114 of the mounting base 102. With the mounting base 102 assembled to the mounting plate 125 and the and the switch body 104 and shim 106 extending therefrom, the pedal arm 126 including the target 128 may be moved to a position adjacent the switch assembly 100. The switch body 104 may be positioned within the mounting base 102 so that the extended shim 106 contacts the pedal arm 126 with the target 128, thereby providing the desired spacing between the switch and the target. As shown in FIG. 11, after the switch body 104 has been positioned relative to the target 126 in the foregoing manner, the shim 106 may be withdrawn so that it does not extend beyond the switch body 104. Accordingly, switch assembly 100 may be adjusted so that the pedal and target 126 may not contact any portion of the switch assembly 100.

With reference to FIGS. 13-20, another embodiment of a non-contact switch assembly 200 is disclosed. Similar to the preceding embodiment, the switch assembly 200 may be calibrated relative to a target 202, such as a portion of a pedal assembly, a flag associated with a movable component, etc., to provide an air space between the switch assembly 200 and the target 202. The air space between the switch assembly 200 and the target 202 may, for example, prevent the occurrence of an audible noise associated with contact between the switch assembly and the target 202 and/or may reduce the likelihood of the switch assembly being moved out of position as a result of contact with the target 202. Various additional and/or alternative advantages may also be provided.

As shown, the switch assembly 200 may generally include a mounting block 204 supporting a switch body 206. The switch assembly 200 may additionally include a sleeve 208 disposed at least partially between the switch body 206 and the mounting block 204. The switch body 206 may include a connector 209 and/or other wiring features, such as a pigtail connector, for electrically coupling the switch assembly 200 to other systems. The switch assembly 200 may be mounted to a bracket 210, or other mounting feature. As shown, the mounting block 204 may be disposed extending at least partially through an opening in the bracket 210. The mounting block 204 may include a mounting flange 212 and at least one locking feature 214, such as a resilient tab or snap fit, most clearly depicted in FIG. 15, which may secure the switch assembly 200 to the bracket 210. Various additional and/or alternative features may be employed for securing the switch assembly to a mounting structure.

Consistent with the illustrated embodiment, the switch body 206 may be received at least partially extending through the sleeve 208. In one embodiment, the switch body 206 may be slidably received extending through the sleeve 208. The switch body 206 may be sized relative to the sleeve 208 to provide frictional engagement therebetween. The switch body 206 may, therefore, be slidably positioned within the sleeve 208 and may resist movement relative to the sleeve 208. Additionally and/or alternatively, the switch body and the sleeve may include cooperating features, such as ratchet teeth and detents, configured to permit positioning of the switch body relative to the sleeve and to resist subsequent movement of the switch body relative to the sleeve. In a related manner, the sleeve 208 may be received extending at least partially through the mounting block 204. The sleeve 208 may be sized relative to the mounting block 204 to provide frictional engagement between the sleeve 208 and the mounting block 204, such that the sleeve 208 may resist movement relative to the mounting block 204. As with the switch body and the sleeve, the sleeve and the mounting block may additionally, and/or alternatively, include various cooperating features that may allow the sleeve to be positioned relative to the mounting block and to then resist undesired movement of the sleeve relative to the mounting block.

The sleeve 208 and the mounting block 204 may include cooperating cam features allowing axial movement of the sleeve 208 relative to the mounting block 204. In the illustrated embodiment, the sleeve 208 may include at least one cam detent 216 configured to be at least partially received in a cam groove 218 of the mounting block 204. As mentioned, the interaction of the cam detent 216 and the cam groove 216 may provide an axial movement of the sleeve 208 relative to the mounting block 204 in response to rotation of the sleeve 208 relative to the mounting block 204. Various additional and/or alternative embodiments may be provided for achieving axial movement of the sleeve relative to the mounting block in response to rotation of the sleeve relative to the mounting block, e.g., at least one cam groove associated with the sleeve and a cooperating cam detent associated with the mounting block, multiple cam grooves and cam detents associated with the sleeve and mounting block, etc.

According to one embodiment, the cam detent 216 may be a deflectable member protruding from the sleeve 208. In one such embodiment, the cam detent 216 may be deflectable inwardly toward the interior of the sleeve 208. Accordingly, the cam detent 216 may inwardly deflect when the sleeve 208 is inserted into the mounting block 204. The cam detent 216 may recover, either resiliently or through an applied force, when the cam detent 216 is aligned with the cam groove 218 of the mounting block 204. In one such embodiment, the switch body 206 may be positioned extending at least partially though the sleeve 208 in the region of the cam detent 216, thereby resisting subsequent inward deflection of the cam detent 216. Accordingly, when the switch body 206 is positioned extending at least partially through the sleeve 208, the sleeve 208 may resist separation from the mounting block 204.

The switch assembly 200 may be calibrated to provide a non-contact arrangement relative to the target 202, in which the switch assembly 200 is spaced apart from the target 202. With particular reference to FIGS. 13-15, the switch assembly 200 may be coupled to the mounting bracket 210, e.g. by capturing the mounting bracket 210 between the mounting flange 212 and the at least one locking feature 214. The sleeve 208 may be positioned at least partially received through the mounting block 204 and the switch housing 206 may be received extending at least partially though the sleeve 206. As shown in FIG. 14, the sleeve 204 may be positioned with the cam detent 216 received in a forward region of the cam groove 218 adjacent to the end of the mounting block 204 that is adjacent to the target 202. The switch body 206 may be received through the sleeve 208 such that an end 220 of the switch body 206 contacts the target 202. The sleeve 208 may then be rotated relative to the mounting block 204. Rotation of the sleeve 208 relative to the mounting block 204 may move the cam detent 216 from the forward region of the cam groove 18 to a retracted region of the cam groove 18, which is away from the end of the mounting block 204 adjacent to the target 202. The movement of the cam detent 216 in the cam groove 218 may move the sleeve 208, and the switch body 206 received at least partially therethrough, away from the target 202. Accordingly, the switch body 206 may be spaced apart from the target, as shown in FIG. 15, to provide an airspace therebetween.

FIGS. 21 and 22 respectively depict switch performance for a non-contact programmable Hall switch consistent with the present disclosure. Consistent with an embodiment corresponding to the graph shown in FIG. 21, a non-contact sensor for a brake switch application may be provided spaced apart from a flag or target being detected, e.g., by about 1 mm in the illustrated embodiment. With the Hall Zone 250a programmed to provide switching in the general range of 100-130 gauss, the sensor may change state after 1.1 mm of flag travel, with a =/−0.4 mm zone, providing a 0.8 mm switch zone 252a. As indicated, the Hall zone may be programmed higher or lower on the gauss scale to provide desired placement of the switch zone along the path of travel of the flag.

In the embodiment depicted in FIG. 22 the Hall Zone 250b has been programmed to provide switching in the general range of about 205-235 gauss in a switch arrangement in which there is a zero gap between the flag and the sensor in a rest position. With the Hall zone programmed in this range and a zero flag gap, the sensor may change states after approximately 1 mm of pedal travel within a =/−0.2 mm switch zone 252b.

FIG. 23 depicts an electronic circuit 300 which may be used in connection with a non-contact switch to adjust the performance of the non-contact switch. Consistent with the illustrated embodiment, a programmable Hall sensor 302 may be used in combination with a transistor 304 that creates a second output. The circuit 300 may provide a fast response time, e.g. of about 50 microseconds at a current draw of about 5 milliampere, for the switch along with an high switch point tolerance.

FIG. 24 depicts an electronic circuit 400 that may be used in connection with a non-contact switch to reduce the current draw of the switch and may be used to increase the response time of the switch. The circuit 400 may include one non-programmable, low power Hall sensor 402 in combination with a regulator 404 and a plurality of transistors 406, 408, 410 to create a second output. The circuit 400 may reduce the power consumption of the switch, for example, to about 460 microampere, and may provide a response time of the switch of about 240 microseconds.

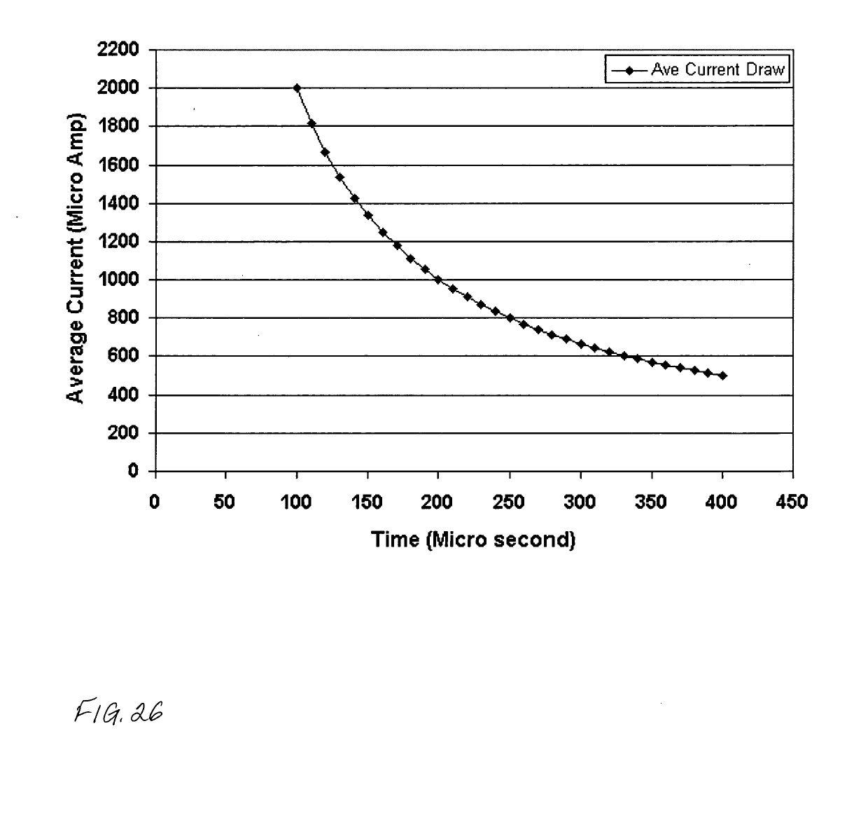

Yet another electronic circuit 500 that may be used in connection with a non-contact switch. The depicted circuit 500 may include a programmable Hall sensor 502 in combination with a regulator 504, an oscillator 506, logic gates 508, 510 and a plurality of transistors 512, 514, 516 to create a second output. The circuit 500 may provide increased switch point tolerance along with low power consumption and a fast response time. A graph of current draw versus response time for a switch utilizing the electronic circuit 500 is shown in FIG. 26. As shown, the circuit 500 may allow the current and response time to be selected according to the curve to suit a particular application.

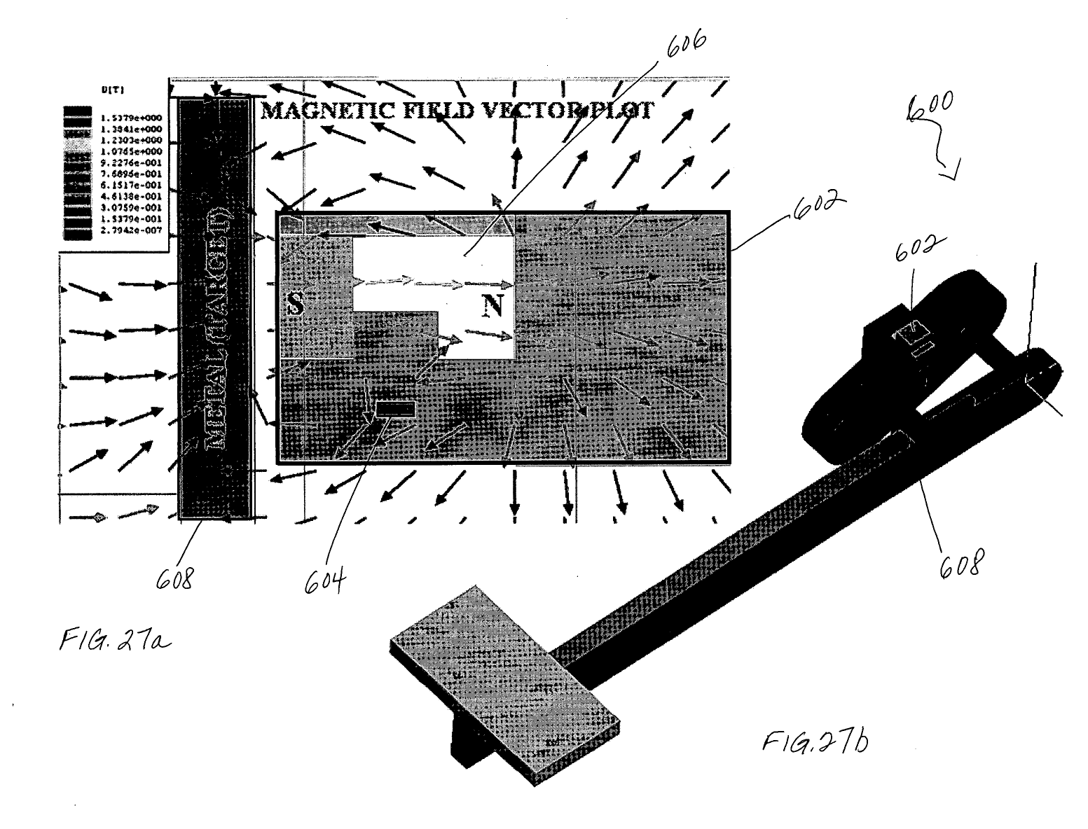

An embodiment of a non-contact switch assembly 600 including a switch housing 602 including a Hall Effect switch 604 and a magnet 606 is shown in FIG. 27b. As shown in the magnetic field vector plot of FIG. 27a, as a ferrous metal target 608 approaches the switch housing 602, the neutral axis of the magnet 606 may shift. The shift in the neutral axis of the magnet 606 changes the magnetic flux imparted on the Hall Effect switch 604 and may cause a change the state of the Hall Effect switch 604. Consistent with the illustrated embodiment, the change in the magnetic flux imparted on the Hall Effect switch 604 as the metal target 608 approaches the switch housing 602 may be enough to cause a change in the state of the Hall Effect switch 604 when the metal target 608 is at least partially spaced from the switch housing 602. Accordingly, the state of the Hall Effect switch 604 may be changed while still maintaining an air gap between the switch housing 602 and the metal target 608. Contact between the switch housing 602 and the metal target 608 may not, therefore, be necessary to change the state of the Hall Effect switch 602.

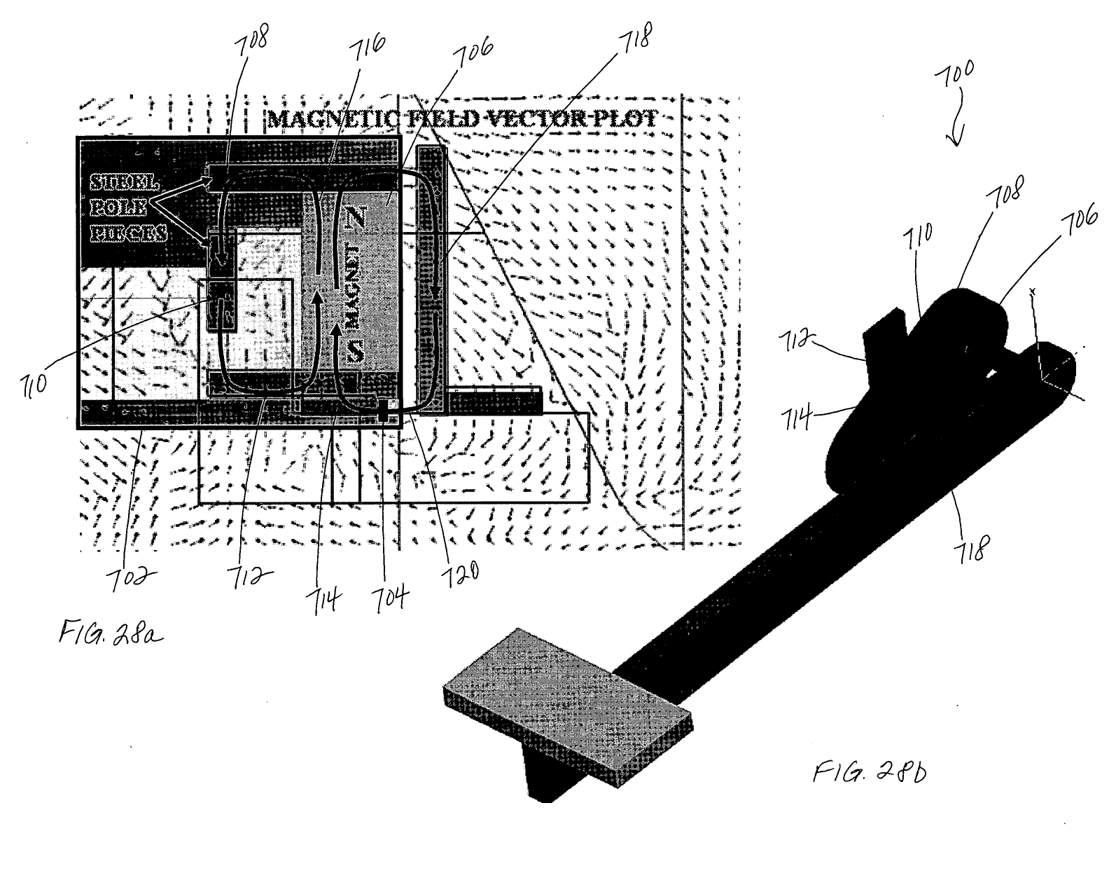

Another embodiment of a non-contact switch 700 is depicted in FIGS. 28a and 28b. The non-contact switch may include a switch housing 702 (omitted for clarity in FIG. 28b) including a Hall Effect switch 704 and a magnet 706. The magnet 706 may include a plurality of associated pole pieces 708, 710, 712, 714. Various additional and/or alternative embodiments may include a greater or lesser number of pole pieces. The pole pieces 708, 710, 712, 714 may establish a first magnetic circuit 716 when a target 718 is outside of a switching range from the non-contact switch 700. As shown, in the case of the first magnetic circuit 716 the magnetic flux imparted on the Hall Effect switch 704 may be below a threshold required to change the state of the Hall Effect switch 704. When the metal target 718 is brought within a switching range of the non-contact switch 700, a second magnetic circuit 720 may be established. As depicted, the second magnetic circuit 720 may include the metal target 718. The second magnetic circuit 720 may impart greater magnetic flux on the Hall effect switch 704 than the first magnetic circuit 716. The magnetic flux imparted on the Hall Effect switch 704 by the second magnetic circuit 720 may be above a threshold for changing the state of the Hall Effect switch 704, and thereby may change the output of the switch 700. As shown, the metal target 718 may establish the second magnetic circuit 720 without contacting the switch 700. That is, the metal target 718 may change the state of the Hall Effect switch 704 while still maintaining an air gap between the target 718 and the switch.

The preceding description discloses various embodiments of non-contact switches, mounting and/or calibration assemblies, electronic circuits, etc. It should be understood that the disclosed features, aspects, and embodiments may be susceptible to combination with one another. Furthermore, the various features, aspects, and embodiments described herein are set forth for the purposed of illustration, and are susceptible to variation and modification within the spirit and scope of the present invention. Accordingly, the present invention should not be construed as being limited to the described embodiments and should be afforded the full scope of the appended claims.

What is claimed is:

1. A switch assembly comprising:
a mounting base comprising an opening, and
a switch housing at least partially receivable in said opening of said mounting base and axially positionable relative to said mounting base, said switch housing comprising a non-contact switch at least partially disposed in said switch housing; and
a calibration feature configured to move between a first position and a second position to provide an airspace between said switch housing and a target.

2. A switch assembly according to claim 1, wherein said non-contact switch comprises a Hall Effect switch.

3. A switch assembly according to claim 1, wherein said switch housing is movably adjustable relative to said mounting base.

4. A switch assembly according to claim 1, wherein said calibration feature comprises a shim, said shim movable between a first position and a second position relative to said switch body, said shim at least partially extending beyond said switch housing in said first position.

5. A switch assembly according to claim 4, wherein said shim is slidably coupled to said switch housing.

6. A switch assembly according to claim 1, wherein said calibration feature comprises a sleeve at least partially disposed between said switch housing and said mounting base, said sleeve movable between a first position and a second position relative to said mounting base.

7. A switch assembly according to claim 6, wherein said sleeve and said mounting base comprise cooperating cam features configured to move said sleeve relative to said mounting base.

8. A switch assembly according to claim 7, wherein said cooperating cam features move said sleeve relative to said mounting base upon rotation of said sleeve relative to said mounting base.

9. A switch assembly according to claim 6, wherein said switch housing is configured to move with said sleeve relative to said mounting base

10. A method of locating a non-contact switch comprising:
locating a mounting base relative to a target;
providing a switch assembly to said mounting base, said switch assembly comprising a movable calibration feature and a switch housing;
coupling said switch assembly to said mounting base with said calibration feature in a first position; and
moving said calibration feature to a second position to provide an airspace between said switch housing and said target.

11. A method according to claim 10, wherein said calibration feature comprises a shim, said shim at least partially extending from said switch housing in said first position.

12. A method according to claim 11, wherein coupling said switch assembly to said mounting base comprises coupling said switch housing to said mounting base with said shim in said first position at least partially extending from said switch housing, said shim contacting said target.

13. A method according to claim 10, wherein said calibration feature comprises a sleeve movable between a first position and a second position relative to said mounting base, said switch housing capable of being coupled to said sleeve.

14. A method according to claim 13, wherein coupling said switch assembly to said mounting base comprises coupling said switch housing to said sleeve and coupling said sleeve to said mounting base in said first position via cooperating cam features.

15. A method according to claim 14, wherein coupling said switch housing to said sleeve comprises positioning said switch housing in contact with said target.

16. A method according to claim 14, wherein moving said calibration feature to a second position comprises moving said sleeve to said second position relative to said mounting base via said cooperating cam features, and wherein moving said sleeve to said second position comprises moving said switch housing away from said target.

17. A non-contact sensor comprising:
a magnet;
a first and second pole piece adjacent each pole of said magnet, a first end of said first and second pole pieces extending outwardly from said magnet; and
a magnetic field sensor disposed adjacent to said first pole piece.

18. A non-contact sensor according to claim 17, further comprising a third pole piece extending between said first end of said first and second pole pieces.

19. A non-contact sensor according to claim 18, further comprising a fourth pole piece disposed adjacent to said first pole piece and said magnetic field sensor.

20. A non-contact sensor according to claim 17, wherein said magnetic field sensor comprises a Hall Effect sensor.
